(19) United States
(12) Patent Application Publication
(10) Pub. No.: US 2004/0117313 A1
(43) Pub. Date: Jun. 17, 2004

(54) System and method for secure downloading

(76) Inventors: James M. Mattern, Bethany, CT (US); George M. Brookner, Norwalk, CT (US); Pascal Charroppin, Le Vesinet (FR)

Correspondence Address: PERMAN & GREEN, 425 POST ROAD, FAIRFIELD, CT, 06824, US

(21) Appl. No.: 10/355,867

(22) Filed: Jan. 31, 2003

Related U.S. Application Data
(60) Provisional application No. 60/429,421, filed on Nov. 26, 2002.
(60) Provisional application No. 60/429,449, filed on Nov. 26, 2002.
(60) Provisional application No. 60/429,760, filed on Nov. 26, 2002.
(60) Provisional application No. 60/429,761, filed on Nov. 26, 2002.

(51) Int. Cl. G06F 17/60

(52) U.S. Cl. 705/60; 705/51

(57) ABSTRACT

A method of downloading information to an indicia marking device includes generating a request for information for the device, providing a description of the information to the device in response to the request, confirming the request based on the description, and providing the requested information upon recognizing the confirmation. The method also includes providing an authorization code to the device, and utilizing the authorization code to install files associated with the information. The method further includes establishing a real time connection between a first computer and the device through a second computer, and providing files associated with the information through the real time connection. The method still further includes retrieving files and storing files associated with the information, and providing the files to the device during a next occurring communication.

### CROSS-REFERENCE TO RELATED APPLICATIONS

This application claims priority from U.S. Provisional Application Nos. 60/429,421, 60/429,449, 60/429,760, and 60/429,761, all filed on Nov. 26, 2002.

### BACKGROUND OF THE INVENTION

1. Field of the Invention

The present invention relates to exchanging information, and, more particularly, to techniques for downloading information to a target device in response to a confirmation from the target device.

2. Brief Description of Related Developments

A high volume postal customer may use a meter which incorporates a Postal Security Device (PSD) to secure the proof of payment of postal indicia. The indicia is applied to mailing items that identifies the value of the postage applied and other information. The customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery.

In various countries, for example the United States, postal meters may communicate with a remote data center to have postage funds replenished. In the United States, a postal customer generally may add postage to the meter in two ways. The first is to physically take the meter to the postal authority, generally referred to herein as “the post,” where postage is purchased and added to the PSD. The second is to remotely add postage over a network, for example, a telephone line with a modem, or the Internet, where the added postage is deducted from an account usually maintained with a meter vendor or a trusted third party administrator, for example, a financial institution. In this case, customer or postal authority access to a meter's accounting system or memory system generally is not possible. Meters with this type of communication capability may initiate communication with a host computer to add funds or to reestablish authenticity. A communication cycle may be initiated automatically, or by a user of the meter.

Occasionally, a meter may require an update to its operating software, may be in need of an update or change to the ancillary services it provides (for example, postal rates), or generally may require a download of information of some type.

For example, while postal equipment is generally extremely reliable, a meter failure may occur causing the user some inconvenience. When a program or other type of data needs to be installed to remedy the problem, a field repair is not practical due to the secure nature of the meter. Therefore, a replacement meter must be provided, further lengthening equipment “down time” for the customer. In the case of a postal meter, the failed device needs to be removed from service, the postal authority notified, a replacement unit logged with the postal authority, and the replacement unit must then be provided to the customer.

Should ancillary services be desired (for example, additional postal rates), the additional service modification or upgrade may be provided in the form of a chip card, floppy disk, etc. However, physically delivering a program or data on media requires ordering the service, time to ship the media, and requires a user or technician to install the program or data.

It would be advantageous to supply services, upgrades, revisions, programs and generally provide information of various types through a remote downloading methodology and system.

### SUMMARY OF THE INVENTION

The present invention is directed to a method of downloading information to an indicia marking device. In one embodiment, a method includes generating a request for information for the device, providing a description of the information to the device in response to the request, confirming the request based on the description, and providing the requested information upon recognizing the confirmation. The method also includes providing an authorization code to the device, and utilizing the authorization code to install files associated with the information. The method further includes establishing a real time connection between a first computer and the device through a second computer, and providing Ifiles associated with the information through the real time connection. The method still further includes retrieving files and storing files associated with the information, and providing the files to the device during a next occurring communication.

In one aspect, the present invention is directed to a system for downloading information. The system includes a first computer, an indicia marking device connected to the first computer, and a mechanism for generating an information request to the first computer. The first computer sends a description of the information to the device in response to the request. The device has a user interface for confirming the request based on the description, and the first computer provides the requested information upon recognizing the confirmation. The system also allows for providing an authorization code for installing files associated with the information. The system further includes a second computer and a real time connection between the second computer and the device through the first computer for providing files associated with the information. The first computer has a storage device for retrieving files and storing files associated with the information and is operable to provide the files to the device during a next occurring communication.

### BRIEF DESCRIPTION OF THE DRAWINGS

The foregoing aspects and other features of the present invention are explained in the following description, taken in connection with the accompanying drawings, wherein:

FIG. 1 shows a block diagram of a system suitable for practicing the invention;

FIG. 2 shows a general block diagram of a meter for providing markings;

FIG. 3 shows a flow diagram of operations associated with the present invention;

FIG. 4 shows another embodiment of the present invention; and

FIG. 5 shows yet another embodiment of the present invention.

### DETAILED DESCRIPTION OF THE PREFERRED EMBODIMENTS

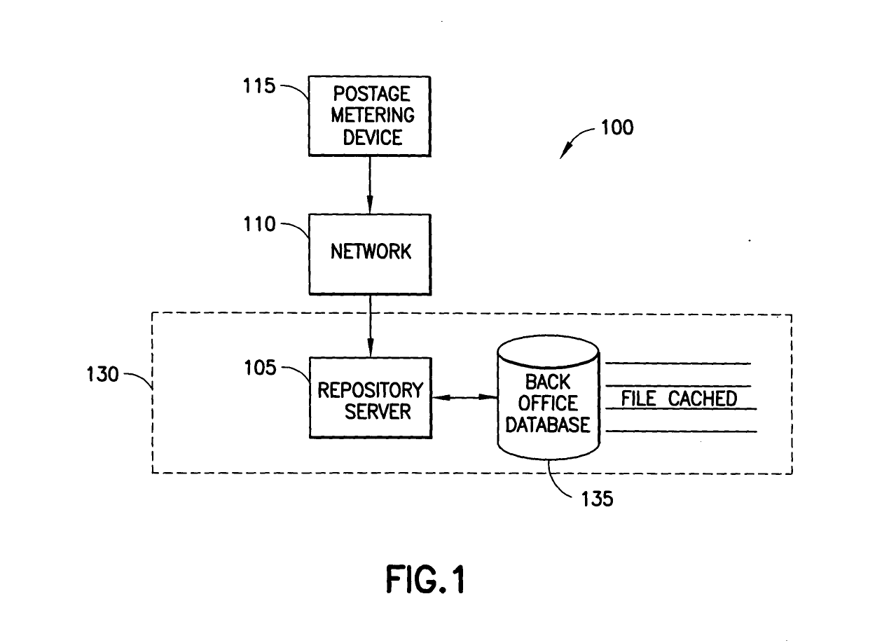

FIG. 1 shows a block diagram of a system 100 suitable for practicing the invention disclosed herein. Although the present invention will be described with reference to the embodiment shown in the drawings, it should be understood that the present invention can be embodied in many alternate forms of embodiments. In addition, any suitable size, shape or type of elements or materials could be used.

System 100 includes an indicia producing or marking function, shown in FIG. 1 as a meter 115, connected to a data storage and delivery function, shown generally as an enterprise 130 through a network 110. The marking function 115 generally provides indicia that has value, for example, postage, tickets allowing admission to an event or allowing the use of a service, and the like. The data storage and delivery function 130 provides updates, programs that allow additional functionality, replacement programs, data tables and other data and information to the marking function. The data storage and delivery function 130 may include a computer 105 and a database 135 for storing information to be delivered, which will be referred to herein as a download. In alternate embodiments, system 100 may include other suitable components or functions for implementing the present invention.

It is a feature of the present invention for the data storage and delivery function to provide a description of a requested download in response to a request for the download. A user confirms the request based on the description and the download proceeds based on the confirmation.

Referring to FIG. 1 in greater detail, computer 105 is coupled to a first data communications network 110. One or more devices suitable for providing postal indicia, in this example meter 115, are also coupled to first communications network 110, and may communicate bi-directionally through first communications network 110 with computer 105. While a single computer 105 is shown, computer 105 may represent a plurality of computers, and these computers may be situated at a single location, or they may be widely distributed and remotely sited. For example, a plurality of distributed computers 105 may be used for servicing meters 115 in different geographic locations, according to particular postal regulations, such as North America, South America, Europe, Africa, Japan and Southeast Asia. Alternately, a single computer 105 can be used for servicing all meter's 115. Computer 105 could be located at an enterprise location or site 130, which could be an office of a meter provider, or other provider of indicia.

Computer 105 may also include or be connected to one or more databases 135 that may store, in addition to downloads, data related to the status, capabilities, characteristics or other information about the one or more meters 115. The one or more databases 135 may be centralized at a specific location or may be distributed among a number of distributed computers.

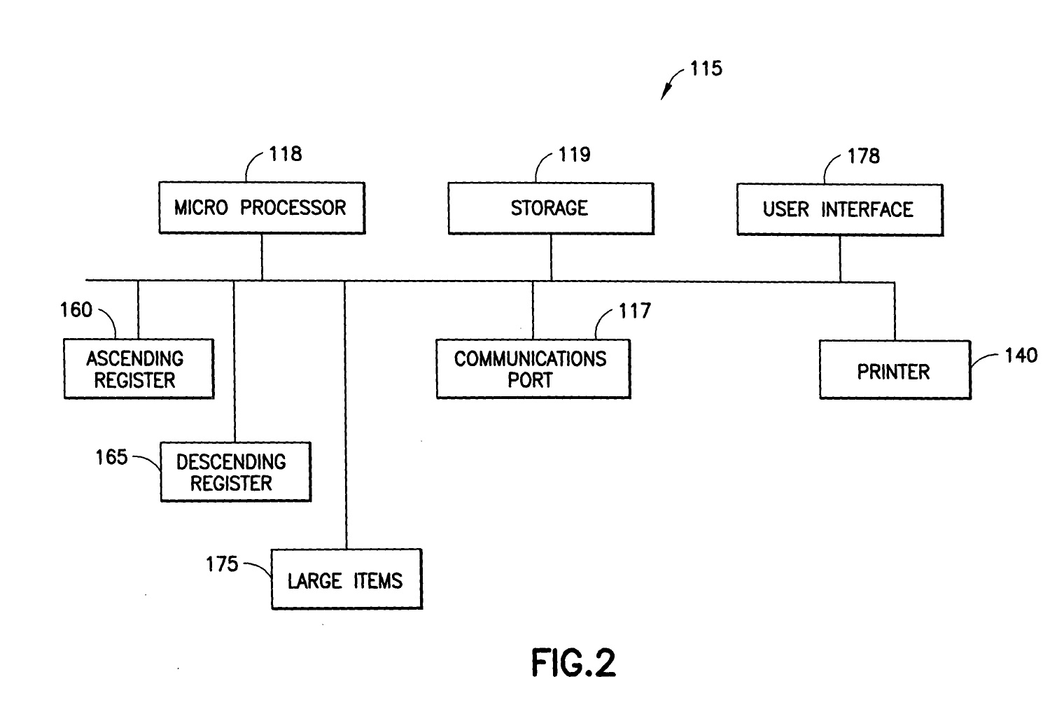

FIG. 2 shows a general block diagram of meter 115. Meter 115 may include a communications port 117 and a microprocessor 118 for performing electronic accounting and control functions, franking functions, and handling functions according to programs stored in a storage device 119. Some of these functions or subsets of these functions may be grouped within a secure perimeter as what is commonly referred to as a Postal Security Device (PSD).

Microprocessor 118 typically performs electronic accounting functions in relation to franking items with indicia showing a value. Data associated with the accounting functions may include an accumulated total value of credit entered into the PSD, an accumulated total value of charges dispensed by the PSD by franking items, a count of the number of items franked, and a count of the number of items franked with a charge in excess of a predetermined value. The accumulated total value of credit may be stored in an ascending credit register 160, the accumulated total value of postage charges dispensed may be stored in a descending register 165, the count of items may be stored in an items count register 170, and the count of items franked with a charge in excess of a predetermined value may be stored in a large items register 175. The various registers may be located in storage device 119.

The franking functions typically include marking items with indicia and reporting the number of items, value marked and other parameters to the accounting functions.

The control functions may include exchanging information with a user through a user interface 178, uploading postage funds, downloading accounting data, and secure communications with computer 105 through network 110, including implementing new public key, private key combinations. According to the present invention, the control functions may also include requesting and installing downloads from computer 105, including software upgrades, operating systems, additional services, service enhancements and the like. To support the control functions, storage device 119 may also include a PSD Public Key, Private Key combination specific to the PSD, a Vendor Public Key specific to the vendor of meter 115, a meter serial number, information regarding software and services installed on meter 115, the present time and date, and other parameters.

Meter 115 may be preloaded with a number of functions or services that are disabled, but that may be enabled in the future. For example, meter 115 may also include a ticket printing capability or the capability to compute rates for various carriers or for other government run postal services. These capabilities may be installed during the manufacture of meter 115 but may not be enabled until a user pays for them. Meter 115 may have or be integral to a device for marking objects with postal indicia, shown in this embodiment as a printer 140.

While meter 115 is described in the context of a postage meter, it should be understood that meter 115 may be any device suitable for providing markings signifying value.

First communications network 110 may include any suitable communications network, for example, the Public Switched Telephone Network (PSTN), a wireless network, a wired network, a Local Area Network (LAN), a Wide Area Network (WAN), virtual private network (VPN) etc. Meter 115 may communicate with computer 105 using any suitable protocol, or modulation standard, for example, X.25, ATM, TCP/IP, V34, V90, etc.

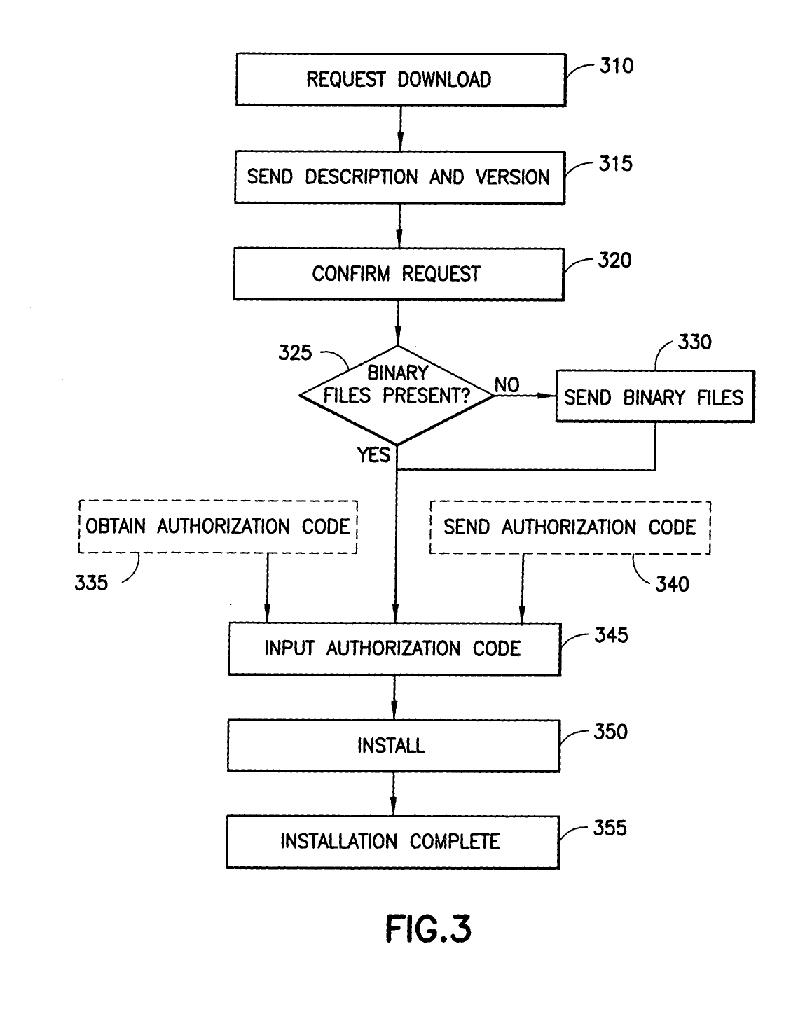

The operation of one embodiment of the present invention will now be described with reference to FIG. 3. A user may request a download as shown in block 310. The download may be, for example, a software update, an additional service capability, a new rate table, etc. The request may be made by the user directly to enterprise 130, for example through a telephone call, by written request, through an Internet web page, etc., or may be made through user interface 178 of meter 115. Meter 115 then communicates with computer 105 through network 110 as part of an automatic or user initiated communication. Computer 105 responds to the request by sending a description of the download and its version back to meter 115 as shown in block 315.

In block 320, the meter user verifies that the description and version correspond to the requested download and confirms the request for the download. Upon receiving the confirmation, computer 105 determines if the files associated with the download are already present in meter 115 as shown in block 325. If the files are not present, computer 105 sends them to meter 115 as shown in block 330. In addition, depending on the status of a user's account, computer 105 may also send an authorization code that enables the use of the download (block 340), or may send a message notifying the user to obtain an authorization code (block 335).

If the user receives a message to obtain an authorization code, the user may contact enterprise 130 for the proper code. Upon obtaining an authorization code, either from computer 105 with the description, or separately from enterprise 130, the user inputs the authorization code into meter 115 as shown in block 345. The installation process proceeds (block 350). Upon completion (block 355), meter 115 is upgraded or has additional capabilities.

Enterprise 130 employs the above mentioned authorization code mechanism to enforce right-to-use matching of meter requested downloads to the meter's authorization to use the downloads. The authorization number may be encrypted from a set of constituent elements, including a unique meter serial identification number. The substitution of a meter identification serial number or a transaction identifier triggers a corresponding change to the authorization number. Enterprise 130 may use a database 135 to compile the authorization number from stored data files, and then may issue the authorization number to the meter 115 or directly to a user.

Meter 115 may utilize the authorization code to enable installation of a download in the following manner. Meter 115 may calculate a second authorization code by extracting a transaction number from the description and version, retrieving constituent elements identical to those stored by enterprise 130, compiling an authorization number using an algorithm complementary to that implemented by enterprise 130, and comparing the result to the authorization code entered by the user. A successful match permits installation and access to the additional or updated feature.

In another embodiment, meter 115 may transmit its present authorization number to computer 105 as part of the information exchanged during the download request and implementation process. Computer 105 than identifies whether the present authorization number allows the download. If the download is authorized, computer 105 proceeds to download the associated files to meter 115. If the status of the user's account allows, computer 105 may also download a new authorization number to be used for a future transaction.

In the event the download is not authorized, computer 105 would so indicate during the next transmission period. Subsequent follow up by the user of meter 115 could be performed manually, or the download may be provided automatically upon adjustment of the user's account. Thus, downloads could be automatically ordered provided the user's account is appropriately established, for example, to provide for payment, credit, billing, or the like.

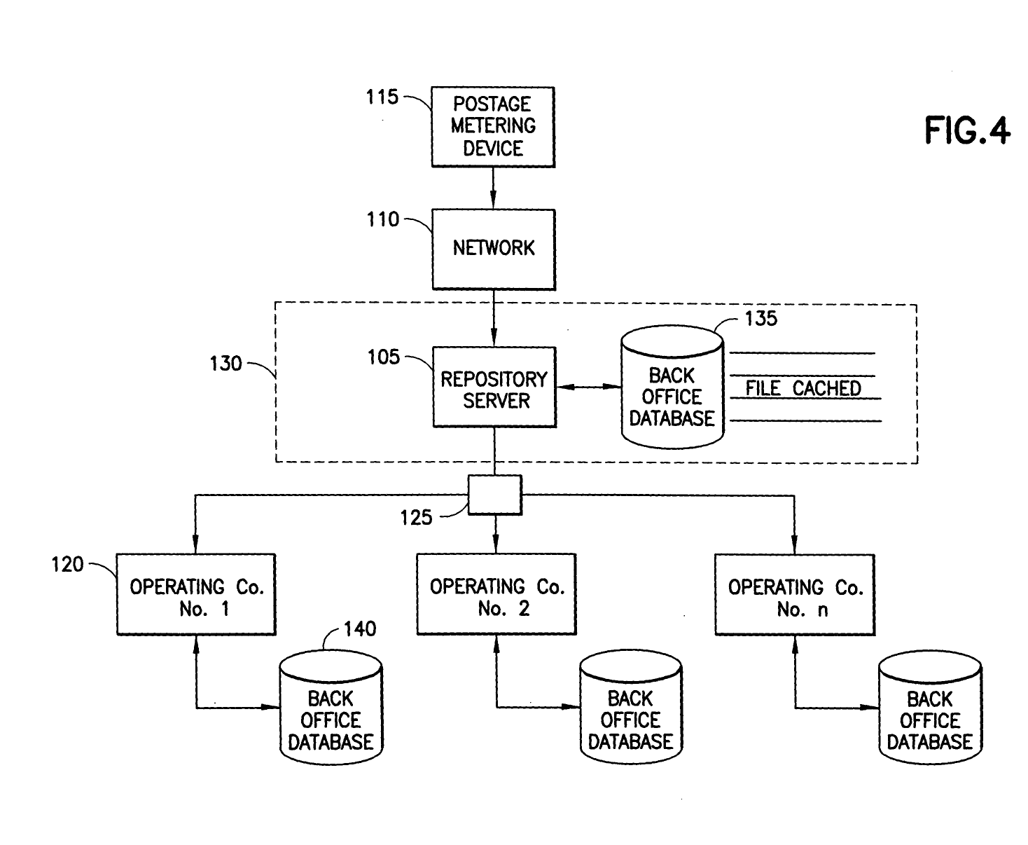

FIG. 4 shows another embodiment of the present invention. In this embodiment, computer 105 may also be connected, or adapted to establish a communication channel to computers at one or more remote operating companies 120 through a second communication network 125. The one or more operating companies 120 generally provide services available through meter 115 and may be meter manufacturers, postal service providers, etc. The operating companies may be part of enterprise 130, or may be separate entities.

Similar to first communication network 110, second communication network 125 may include any suitable communications network, for example, the Public Switched Telephone Network (PSTN), a wireless network, a wired network, a Local Area Network (LAN), a Wide Area Network (WAN), virtual private network (VPN) etc. Operating companies 120 may communicate with the computer 105 using any suitable protocol, or modulation standard, for example, X.25, ATM, TCP/IP, V34, V90, etc. In another embodiment, first and second communications networks 110, 125 may be the same communication network.

In the present embodiment, a real time communication path may be established between meter 115 and operating company 120 through network 125, computer 105, and network 110 as part of the download request and provision process.

A user may request a download by contacting operating company 120 directly, for example by telephone, or through user interface 178 of meter 115. In this embodiment, during the next communication cycle, computer 105 may identify characteristics of meter 115 including its present operating state, version level, software applications, features, functions, present authorization code, serial number, the associated operating company 120, and the like. The characteristics may be determined from messages exchanged between meter 115 and computer 105 or may be stored in database 135.

Computer 105 then contacts the operating company and initiates a real-time communication path between operating company 120 and meter 115. Computer 105 verifies with operating company 120 that the users account allows for the download and otherwise arranges for a file transfer between operating company 120 and meter 115. Upon confirmation of the appropriate account status, operating company 120 transfers the appropriate files to meter 115 using the procedure described above.

Alternately, the files could be cached at computer 120 for downloading to meter 115.

In this embodiment, computer 105 may not need to maintain files for downloading because each operating company maintains its own set of upgrades, operating systems, options, additional services, and other files for downloading. Computer 105 may optionally buffer a requested download if desired, for example, to reduce traffic through network 125, or to relieve operating company 120 from overhead tasks associated with relatively slow communications with meter 115.

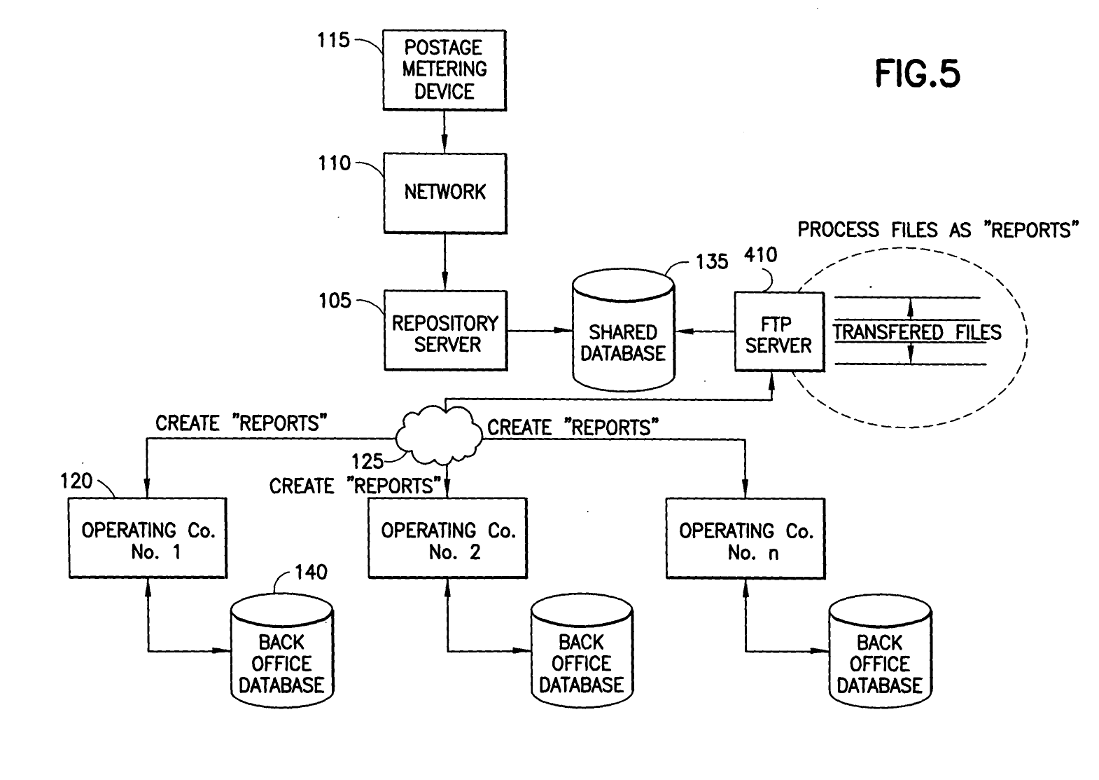

FIG. 5 shows yet another embodiment of the present invention. In this embodiment, real time communication between meter 115 and operating company 120 may not be required. A computing device 410, for example a File Transfer Protocol (FTP) server, is connected between network 125 and database 135 of computer 105. Operating company 120 may send information, for example a report, on each meter for which it provides services, to computing device 410. Reports may be sent on a periodic basis and may generally include a meter profile as maintained by operating company 120, for example, meter payment status, configuration version, rate table revision, features and functions enabled and disabled, performance, capabilities, etc. Computing device 410 may periodically process the information and update computer 105, either automatically or when prompted.

In operation, meter 115 connects to computer 105 as previously described. In response to a download request, computer 105 provides a description and version of the requested download for review by a user of meter 115.

In this embodiment, in addition to responding to a download request, computer 105 may determine which additional services or upgrades are present but disabled or may otherwise be available for meter 115 based on a meter profile for meter 115. Computer 105 may then prompt the user through user interface 178 of meter 115 regarding which additional services or upgrades a user may desire. In addition to re-affirming a user originated request, the user may also affirm one or more additional services or upgrades. Once an affirmation is made, the downloading process is suspended until the next communication cycle.

Computer 105 then requests the files associated with the requested downloads from the appropriate operating company 120. In response, costs and accounts related to the additional services or upgrades for meter 115 are reconciled, and operating company 120 uploads the associated files to computing device 410. During the next communication cycle, computer 105 transfers the files to meter 115 for subsequent processing and installation. The profile for meter 115 may also be updated appropriately.

Alternately, an update of a meter profile may be initiated by computer 105. During a cycle, computer 105 may request meter profile information from meter 115, and may convey the received meter profile information to the appropriate operating company through computing device 410, for example in the form of a report.

Thus, computer 105 is not required to maintain copies of upgrades, additional services, or related files. Rather, computer 105 passes information about the requesting meter 115 to database 135 and on to computing device 410. Communications may occur on a non-real time or other suitable basis between computing device 410 and the appropriate operating company 120 to provide and reconcile payment for upgrades and added services to meter 115.

Each of the above described embodiments may be implemented utilizing additional measures to optimize the communications load on computer 105. As an example, a requested download may include a new rate table in the event of a change in shipping or potage rates. If all customers request new rate tables the day before they become effective, the communications load on computer 105 may be massive.

Another embodiment of the present invention provides for downloading upgrades or additional services in advance to avoid undesirable communication loads. In this embodiment, a user may request a download well in advance of when it may be required to provide sufficient time for delivery in the event that multiple users may desire downloads at the same time. The downloads are then provided in an orderly and balanced fashion to avoid any disturbance or overload. In this embodiment, the files downloaded to meter 115 are provided with an effectivity date, such that the features provided by the files may not be accessed, or may not become active until the effectivity date occurs. As mentioned above, storage device 119 of meter 115 may store the present time and date and thus be able to recognize when the effectivity date occurs.

As part of this aspect of the invention, the downloaded files may be modified before the effectivity date and the effectivity date itself may be modified as desired during a communication cycle of meter 115.

As an example, a postal rate change may be communicated in advance by way of news media, a mailing or some other notification technique. A user may request a download of a new rate table reflecting the new rates well in advance of the day the rates go into effect, or a prior rate customer may obtain a new rate table automatically. The download is installed with an effectivity date that matches the day the new rates become effective. In the event the postal authority changes the date of implementation, meter 115 automatically receives a new effective postal rate implementation date during the next communication cycle, say for a funds reset or addition. As another example, if a user account becomes delinquent, meter 115 may receive an effectivity date that may never be achieved, or the downloaded file may be marked as disabled. This never achievable effectivity date or file marking may be changed again upon the user curing the delinquency. As another example, if the postal authority changes the rates prior to the effectivity date, those new rates are also downloaded during the next predetermined communication period. Once the effectivity date is reached, the new rates become effective in meter 115 without user intervention.

Communication between meter 115 and computer 105 and between computer 105 and operating company 120 may be secured, that is encrypted using any suitable encryption technique, for example a block cipher technique such as Data Encryption Standard (DES), or authenticated, that is, signed using for example, Digital Signature Algorithm (DSA) in conjunction with Public, Key Infrastructure (PKI). Other types of security and authentication may also be used.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of providing information to an indicia marking device comprising:
requesting the information for the device;
providing a description of the information to the device;
confirming the request based on the description; and
providing the requested information to the device upon receiving the confirmation.

2. The method of claim 1, wherein providing the requested information further comprises:
providing an authorization code to the device; and
utilizing the authorization code to install files associated with the information.

3. The method of claim 1, wherein providing the requested information further comprises:
establishing a real time connection between a first computer and the device through a second computer; and
providing files associated with the information through the real time connection.

4. The method of claim 1, wherein providing the requested information further comprises:
retrieving files and storing files associated with the information; and
providing the files to the device during a next occurring communication.

5. A system for downloading information comprising:
a first computer;
an indicia marking device connected to the first computer; and
a mechanism for generating an information request to the first computer, wherein the first computer sends a description of the information to the device in response to the request;
the device having a user interface for confirming the request based on the description, wherein the first computer provides the requested information upon recognizing the confirmation.

6. The system of claim 5, wherein an authorization code is provided for installing files associated with the information.

7. The system of claim 5, further comprising:
a second computer; and
a real time connection between the second computer and the device through the first computer for providing files associated with the information.

8. The system of claim 5, wherein the first computer has a storage device for retrieving files and storing files associated with the information and is operable to provide the files to the device during a next occurring communication.
